(19) United States
(12) Patent Application Publication
(10) Pub. No.: US 2018/0358153 A1
(43) Pub. Date: Dec. 13, 2018

(54) OXIDE SUPERCONDUCTING THIN FILM WIRE AND METHOD FOR PRODUCING THE SAME

(71) Applicant: SUMITOMO ELECTRIC INDUSTRIES, LTD., Osaka-shi, Osaka (JP)

(72) Inventors: Masaya KONISHI, Osaka-shi, Osaka (JP); Takashi YAMAGUCHI, Osaka-shi, Osaka (JP)

(73) Assignee: SUMITOMO ELECTRIC INDUSTRIES, LTD., Osaka-shi, Osaka (JP)

(21) Appl. No.: 15/772,182

(22) PCT Filed: Nov. 1, 2016
(86) PCT No.: PCT/JP2016/082488

§ 371 Date: Apr. 30, 2018

(30) Foreign Application Priority Data
Nov. 5, 2015 (JP) 2015-217530
Nov. 5, 2015 (JP) 2015-217532
Nov. 5, 2015 (JP) 2015-217533

(51) Int. Cl. H01B 12/06

(52) U.S. Cl. CPC H01B 12/06

(57) ABSTRACT

A method for producing an oxide superconducting thin film wire having a particular width includes a cutting step of cutting a wide oxide superconducting thin film wire in a longitudinal direction with the particular width, the wide oxide superconducting thin film wire being obtained by forming an oxide superconducting layer above a belt-shaped metal substrate with an intermediate layer disposed therebetween. In the cutting step, the wide oxide superconducting thin film wire is thermally cut in the longitudinal direction with the particular width by irradiating, with infrared laser light, a portion of the wide oxide superconducting thin film wire to be cut.

### TECHNICAL FIELD

The present invention relates to an oxide superconducting thin film wire in which a superconducting layer formed of an oxide superconductor is disposed on a belt-shaped metal substrate and a method for producing the oxide superconducting thin film wire.

### BACKGROUND ART

Since the discovery of oxide superconducting materials having superconductivity at a temperature of liquid nitrogen, oxide superconducting thin film wires aimed at applications to electric power devices such as cables, current limiters, and magnets have been actively developed.

Oxide superconducting thin film wires are generally produced by sequentially forming an intermediate layer, a REBa₂Cu₃O₇₋ₓ-based (RE: rare-earth element) oxide superconducting layer, and a silver layer serving as a protective layer on a metal substrate having a width of about 1 to 10 cm and then cutting the resulting product into wires having a wire width desired for their applications.

Herein, the following methods for cutting such oxide superconducting thin film wires have been employed: a method for mechanically cutting wires using a slitter or the like and a method for cutting wires through laser irradiation with ultraviolet laser light or infrared laser light (PTL 1 to PTL 4).

In such an oxide superconducting thin film wire, a copper (Cu) layer or a copper alloy layer is generally disposed as a stabilizing layer on a surface of the oxide superconducting thin film wire on the oxide superconducting layer side or on the entire peripheral surface of the oxide superconducting thin film wire to prevent the oxide superconducting layer from being broken by an overcurrent.

Furthermore, it has been conceived that the stability during the passage of electric current is ensured using a metal substrate by providing conductivity between the oxide superconducting layer and the metal substrate instead of formation of such a stabilizing layer. Specifically, it has been proposed that the above-described intermediate layer be formed of a conductive material (PTL 5 to PTL 7 and NPL 1).

Long oxide superconducting thin film wires are required to produce, for example, superconducting cables and superconducting coils that use oxide superconducting thin film wires. Therefore, the oxide superconducting thin film wire is lengthened by cutting a plurality of oxide superconducting thin film wires into wires having a desired width and then sequentially connecting the end portions of the cut oxide superconducting thin film wires (PTL 8 and PTL 9).

### CITATION LIST

### Patent Literature

PTL 1: Japanese Unexamined Patent Application Publication No. 06-068727

PTL 2: Japanese Unexamined Patent Application Publication No. 2012-169057

PTL 3: Japanese Unexamined Patent Application Publication No. 2012-156047

PTL 4: Japanese Unexamined Patent Application Publication No. 2012-156048

PTL 5: Japanese Unexamined Patent Application Publication No. 2005-044636

PTL 6: U.S. Pat. No. 6,617,283

PTL 7: U.S. Pat. No. 6,956,012

PTL 8: Japanese Unexamined Patent Application Publication (Translation of PCT Application) No. 2011-515792

PTL 9: Japanese Unexamined Patent Application Publication No. 2007-12582 Non Patent Literature

NPL 1: T. Aytug et al., Electrical and magnetic properties of conductive Cu-based coated conductors, Applied Physics Letters, United States, American Institute of Physics, Nov. 10, 2003, Volume 83, Number 19, pp. 3963 to 3965

### SUMMARY OF INVENTION

### Technical Problem

The above-described oxide superconducting thin film wire in which the oxide superconducting layer is formed above the belt-shaped metal substrate with the intermediate layer disposed therebetween poses various problems from the viewpoint of, for example, improvement in performance and reduction in production cost.

Accordingly, it is an object of the present invention to provide, in the production of oxide superconducting thin film wires, a technique that contributes to improving the performance of oxide superconducting thin film wires produced and reducing the production cost of oxide superconducting thin film wires.

### Solution to Problem

A method for producing an oxide superconducting thin film wire according to one aspect of the present invention is a method for producing an oxide superconducting thin film wire having a particular width, the method including:

a cutting step of cutting a wide oxide superconducting thin film wire in a longitudinal direction with the particular width, the wide oxide superconducting thin film wire being obtained by forming an oxide superconducting layer above a belt-shaped metal substrate with an intermediate layer disposed therebetween,

wherein in the cutting step, the wide oxide superconducting thin film wire is thermally cut in the longitudinal direction with the particular width by irradiating, with infrared laser light, a portion of the wide oxide superconducting thin film wire to be cut.

### Advantageous Effects of Invention

The present invention can provide, in the production of oxide superconducting thin film wires, a technique that contributes to improving the performance of oxide superconducting thin film wires produced and reducing the production cost of oxide superconducting thin film wires.

### BRIEF DESCRIPTION OF DRAWINGS

FIG. 1 is a sectional view illustrating a structure of a thermally cut oxide superconducting thin film wire according to a first aspect of the present invention.

FIG. 2 illustrates a state in which a stabilizing layer is formed on the thermally cut oxide superconducting thin film wire in the first aspect of the present invention.

FIG. 3 illustrates a state in which an insulating layer is formed on the oxide superconducting thin film wire illustrated in FIG. 2.

FIG. 4 is a graph illustrating the relationship between the critical current (Ic) and the wire width of the oxide superconducting thin film wire according to the first aspect of the present invention.

FIG. 5 is a sectional view illustrating a structure of an oxide superconducting thin film wire according to a first embodiment of a second aspect of the present invention.

FIG. 6 is a sectional view illustrating a structure of an oxide superconducting thin film wire according to a second embodiment of the second aspect of the present invention.

FIG. 7 is a sectional view illustrating a structure of an oxide superconducting thin film wire according to a third embodiment of the second aspect of the present invention.

FIG. 8 is a side view schematically illustrating an oxide superconducting thin film wire according to an embodiment of a third aspect of the present invention.

FIG. 9 is a sectional view taken along line A-A in FIG. 8.

FIG. 10 schematically illustrates a section of a connected portion of an oxide superconducting thin film wire according to another embodiment of the third aspect of the present invention.

### DESCRIPTION OF EMBODIMENTS

### <1> First Aspect

First, an oxide superconducting thin film wire according to a first aspect of the present invention and a method for producing the oxide superconducting thin film wire will be described.

### [Specific Problem Solved in First Aspect]

In the known production process of an oxide superconducting wire described above, the method for mechanically cutting a wire provides a high processing speed, but edge portions subjected to cutting and portions near the edge portions are damaged, which causes mechanical deformation. This deteriorates the superconducting properties such as critical current Ic and generates burrs.

The method for cutting a wire through laser irradiation with ultraviolet laser light is an ablation process in which a wire is non-thermally cut by releasing substances constituting the surface using ultraviolet laser light. Therefore, the amount of heat generated is small compared with the case of infrared laser processing, which is thermal processing, and thus the deterioration of the superconducting properties can be suppressed. However, a high-power ultraviolet laser is expensive and generally has a low cutting speed.

On the other hand, when a wire is cut through laser irradiation with infrared laser light, a high cutting speed can be achieved. However, this cutting process is a thermal cutting process in which the surface is thermally melted using infrared laser light and then the resulting melt is evaporated or blown away. Therefore, heat is generated during cutting, which readily deteriorates the superconducting properties.

Under such circumstances, a cutting process with an infrared laser has been highly promising recently from the viewpoint of improving the productivity. There has been a strong demand for a cutting technique that suppresses the deterioration of the superconducting properties while a high cutting speed is maintained.

Accordingly, it is an object of the first aspect of the present invention to provide a method for producing an oxide superconducting thin film wire in which the deterioration of the superconducting properties can be sufficiently suppressed by recovering superconducting properties deteriorated by cutting an oxide superconducting thin film wire at a high cutting speed using an infrared laser.

[Description of First Aspect according to Present Invention]

Hereafter, embodiments of the first aspect according to the present invention will be listed and described.

(1) A method for producing an oxide superconducting thin film wire according to the first aspect of the present invention is a method for producing an oxide superconducting thin film wire by forming a REBa₂Cu₃O₇₋ₓ-based (RE: rare-earth element) oxide superconducting layer above a belt-shaped metal substrate with an intermediate layer disposed therebetween and then performing cutting in a longitudinal direction with a particular width, the method including:

a step of performing thermal cutting in a longitudinal direction with a particular width by irradiating a portion to be cut with infrared laser light; and

a step of heat-treating the thermally cut oxide superconducting thin film wire in an oxygen gas atmosphere.

As described above, cutting through laser irradiation with infrared laser light is thermal cutting and therefore heat generated during cutting increases the temperature of an oxide superconducting thin film wire, which readily deteriorates the superconducting properties.

However, as a result of studies conducted by the present inventors on the deterioration of the superconducting properties with increasing the temperature of an oxide superconducting thin film wire, the following has been found.

The superconducting properties deteriorate at 300° C. to 800° C. because oxygen comes out of an oxide superconductor and deteriorate at 800° C. or higher because the crystals themselves of an oxide superconductor are damaged. In the latter case, the recovery of the superconducting properties is difficult because the crystals themselves are damaged. In the former case, the superconducting properties can be sufficiently recovered if the oxygen that has come out can be caused to enter the oxide superconductor again.

Specifically, it has been found that when an oxide superconducting thin film wire subjected to cutting undergoes heat treatment in oxygen called oxygen annealing in which cooling is slowly performed in an oxygen gas atmosphere, oxygen is caused to enter the oxide superconductor again and the deteriorated superconducting properties are sufficiently recovered.

This aspect is based on the above findings. By performing thermal cutting through irradiation with infrared laser light and then heat-treating the cut oxide superconducting thin film wire in an oxygen gas atmosphere, the superconducting properties deteriorated by cutting the oxide superconducting thin film wire at a high cutting speed are recovered, which can sufficiently suppress the deterioration of the superconducting properties. Therefore, the oxide superconducting thin film wire can be efficiently produced.

An infrared laser that emits laser light having a wavelength of 1.0 to 1.1 μm is most suitable as a laser used for cutting among currently available laser processing apparatuses from the viewpoint of output and spot size.

When thermal cutting is performed with a particular width using an infrared laser, a plurality of oxide superconducting thin film wires each having a particular width are preferably produced by thermally cutting an oxide superconducting thin film wire to be cut from the viewpoint of production efficiency, without producing a single oxide superconducting thin film wire having a particular width by thermally cutting both edges of an oxide superconducting thin film wire to be cut.

(2) This method is effective when the oxide superconducting thin film wire is produced by performing thermal cutting so as to have a width of 1 mm or less.

A region of the oxide superconducting layer whose superconducting properties deteriorate due to thermal cutting with an infrared laser, that is, a region from which oxygen comes out is dependent on the irradiation conditions of infrared laser light regardless of the cutting width. Therefore, as the cutting width decreases, the superconducting properties of the oxide superconducting thin film wire readily deteriorate, but a large effect of recovering the superconducting properties through heat treatment in oxygen is produced. In particular, this effect is considerably exhibited in the production of an oxide superconducting thin film wire having a width of 1 mm or less.

Furthermore, when a plurality of oxide superconducting thin film wires having a width of 1 mm or less are bundled and stranded, for example, bending in a width direction is easily performed. Thus, for example, a superconducting coil can be easily produced.

[Details of Embodiments of First Aspect according to Present Invention]

Hereafter, the first aspect of the present invention will be described based on embodiments with reference to the attached drawings. The present invention is not limited to these examples and is indicated by the scope of the claims. The present invention is intended to embrace equivalents of the scope of the claims and all modifications within the scope of the claims. The same applies to embodiments of a second aspect and embodiments of a third aspect.

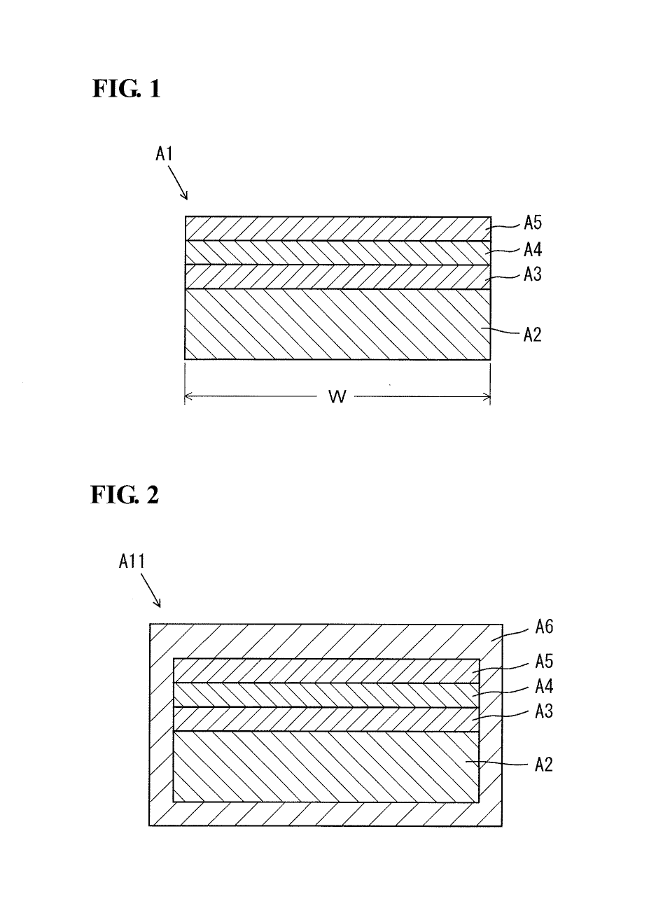

FIG. 1 is a sectional view illustrating a structure of a thermally cut oxide superconducting thin film wire. A1 denotes an oxide superconducting thin film wire, A2 denotes a metal substrate, A3 denotes an intermediate layer, A4 denotes an oxide superconducting layer, and A5 denotes a silver layer serving as a protective layer.

The oxide superconducting thin film wire A1 illustrated in FIG. 1 is produced by producing an oxide superconducting thin film wire before cutting and thermally cutting the oxide superconducting thin film wire in a longitudinal direction with a particular width through irradiation with infrared laser light. Hereafter, the production procedure of the oxide superconducting thin film wire A1 illustrated in FIG. 1 will be described.

### 1. Production of Oxide Superconducting Thin Film Wire Before Cutting

The oxide superconducting thin film wire before cutting is produced by a publicly known method.

### (1) Preparation of Metal Substrate

First, a metal substrate cut so as to have a particular width is prepared. The metal substrate is preferably a belt-shaped orientated metal substrate whose surface is biaxially orientated with respect to a c-axis in order to form an oxide superconducting layer by epitaxially growing an oxide superconductor through c-axis orientation. Specific examples of the substrate include a NiW alloy substrate and a clad metal substrate such as Ni/Cu/SUS that uses SUS or the like as a base metal. Alternatively, for example, an IBAD substrate in which an orientated intermediate layer is laminated on a non-orientated metal substrate may also be employed.

### (2) Formation of Intermediate Layer

Next, an intermediate layer formed of a ceramic is formed on the metal substrate by an RF sputtering method or the like so as to have a particular thickness. Specifically, the intermediate layer is formed of ceramics such as CeO₂, stabilized zirconia, e.g., YSZ, and Y₂O₃. Normally, such ceramics are laminated to form an intermediate layer.

### (3) Formation of Oxide Superconducting Layer

Next, a REBa₂Cu₃O₇₋ₓ-based oxide superconducting layer is formed on the intermediate layer by a publicly known method such as a pulse laser deposition (PLD) method or a metal organic decomposition method (MOD method). Herein, RE refers to a rare-earth element that is suitably selected from yttrium (Y), ytterbium (Yb), gadolinium (GD), samarium (Sm), neodymium (Nd), erbium (Er), europium (Eu), holmium (Ho), and dysprosium (Dy).

### (4) Formation of Silver Layer

Next, if required, a silver layer having a thickness of several micrometers to several tens of micrometers is formed on the oxide superconducting layer by a deposition method such as a DC sputtering method so as to serve as a protective layer for the oxide superconducting layer.

(5) Introduction of Oxygen into Oxide Superconducting Layer

Next, oxygen is introduced into the oxide superconducting layer by performing heating treatment in an oxygen atmosphere. Through the above processes, the production of an oxide superconducting thin film wire before cutting is completed. This process of introducing oxygen into the oxide superconducting layer may be omitted.

### 2. Cutting

Next, the produced oxide superconducting thin film wire before cutting is thermally cut in a longitudinal direction using an infrared laser.

Specific examples of the infrared laser suitably used include fiber lasers and YAG lasers capable of emitting infrared light having a wavelength of 1.0 to 1.1 μm. A continuous-wave laser or a pulsed laser may be employed, but an ultrashort pulsed laser performs an ablation process and thus is not proper in this embodiment for the same reason as ultraviolet lasers.

As described above, during cutting with an infrared laser, the region of the oxide superconducting layer whose superconducting properties deteriorate, that is, the region from which oxygen comes out is not dependent on the cutting width. Therefore, as the cutting width decreases, the influence of oxygen that comes out appears and the superconducting properties of the oxide superconducting thin film wire readily deteriorate, but a large effect of recovering the superconducting properties in the subsequent heat treatment in oxygen is produced. In particular, when the oxide superconducting thin film wire has a cutting width W (refer to FIG. 1) of 1 mm or less, such an effect is considerably produced.

Such an oxide superconducting thin film wire having a width of 1 mm or less can be bent in a width direction in combination with twisting. Therefore, a plurality of oxide superconducting thin film wires can be gathered together to produce a superconductor having flexibility, or a plurality of oxide superconducting thin film wires can be stranded to produce a superconductor with low alternating current loss.

### 3. Heat Treatment in Oxygen

Next, the oxide superconducting thin film wire subjected to cutting using an infrared laser is heat-treated in an oxygen gas atmosphere. Thus, oxygen that has come out of the oxide superconductor during cutting enters the oxide superconductor again, which recovers the deteriorated superconducting properties.

This heat treatment in oxygen is normally performed at a pressure of 1 atmosphere in a pure oxygen atmosphere, but may be performed under pressure. The treatment temperature may be 800° C. or lower. However, the heat treatment needs to be performed for a long time at low temperature, and the above effect is saturated at high temperature. Therefore, the maximum temperature is preferably about 400° C. to 550° C.

Specifically, the oxide superconducting thin film wire is heated to the above treatment temperature, held for a certain time, and then slowly cooled. The time for slow cooling is appropriately set because the time varies in accordance with the type of RE and the structure of wires. For example, when Y is used as RE, the oxide superconductor may be cooled to room temperature within several minutes. However, when Gd is used as RE, the oxide superconductor is slowly cooled to 200° C. over at least 2 hours or longer because the degree of recovery of Ic is highly likely to increase.

This heat treatment in oxygen is normally performed at a pressure of 1 atmosphere in a pure oxygen atmosphere, but may be performed under pressure. The treatment temperature may be 800° C. or lower. However, the heat treatment needs to be performed for a long time at low temperature, and the above effect is saturated at high temperature. Therefore, the maximum temperature is preferably about 400° C. to 550° C.

### 4. Formation of Stabilizing Layer

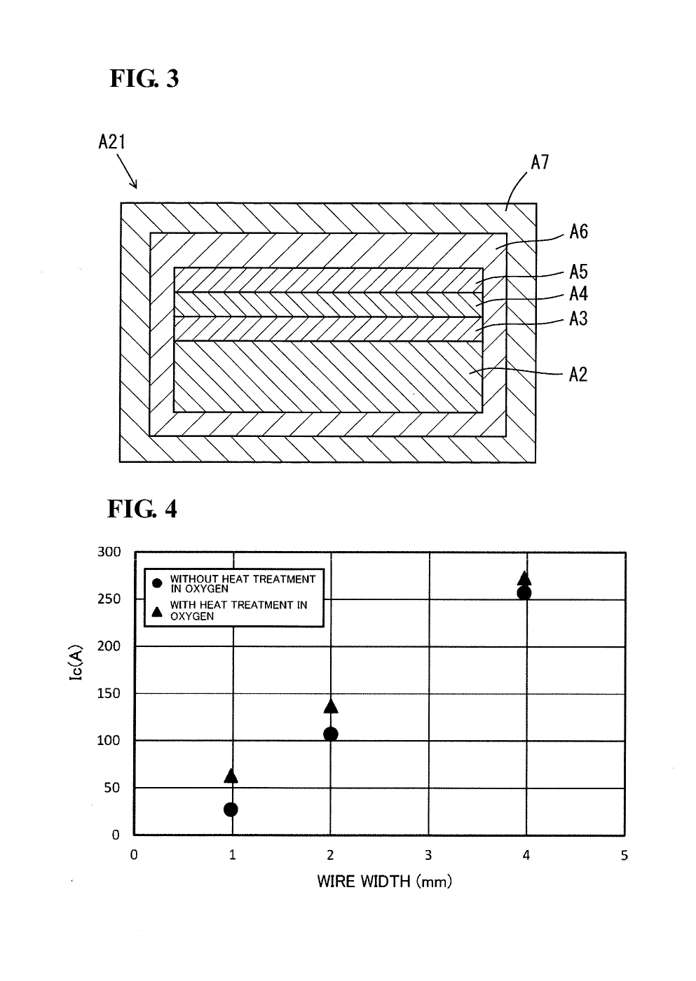

The oxide superconducting thin film wire after the heat treatment in oxygen may include a copper or copper-alloy stabilizing layer A6 formed on the peripheral surface thereof as in an oxide superconducting thin film wire A11 in FIG. 2. Furthermore, as illustrated in FIG. 3, an insulating layer A7 formed of a polyamide resin may be formed on the peripheral surface of the stabilizing layer A6.

Through the above processes, the production of an oxide superconducting thin film wire is completed.

### EXPERIMENTAL EXAMPLES

Next, the first aspect of the present invention will be more specifically described based on Experimental Examples.

Herein, a wide oxide superconducting thin film wire was cut by three different cutting methods such as cutting with an infrared laser, cutting with an ultraviolet laser, and mechanical cutting so as to have different wire widths. Thus, oxide superconducting thin film wires in Experimental Examples A-1 to A-9 were produced with or without heat treatment in oxygen (oxygen annealing after cutting). For each of the produced oxide superconducting thin film wires, Ic was evaluated.

### (1) Production of Wide Oxide Superconducting Thin Film Wire (Before Cutting)

A clad substrate obtained by laminating an orientated Cu layer and an orientated Ni layer on a SUS substrate was provided as a metal substrate. An intermediate layer was formed on the metal substrate by laminating Y₂O₃, YSZ, and CeO₂. A GdBa₂Cu₃O₇₋ₓ oxide superconducting layer was formed on the intermediate layer as an oxide superconducting layer. Furthermore, a silver layer serving as a protective layer was formed on the oxide superconducting layer. Thus, an oxide superconducting thin film wire having a width of 10 mm was produced.

### (2) Cutting Conditions

The produced oxide superconducting thin film wire having a width of 10 mm was thermally cut using an infrared laser in Experimental Examples A-1 to A-6 and non-thermally cut using an ultraviolet laser in Experimental Examples A-7 and A-8. The oxide superconducting thin film wire was mechanically cut in Experimental Example A-9.

The cutting conditions with an infrared laser were set to be as follows.

Laser: Fiber laser

Wavelength: 1.064 μm

Output: 300 W

Assist gas: N₂

Processing speed: 50 m/min

The cutting conditions with an ultraviolet laser were set to be as follows.

Laser: Third harmonic of YAG laser

Wavelength: 0.355 μm

Output: 4 W

Assist gas: not used

Processing speed: 6 mm/min

In the cutting with an infrared laser, the cutting widths were 1.5 mm, 4 mm, 2 mm, 1 mm, and 1.5 mm from the end. In the cutting with an ultraviolet laser, the cutting widths were 3 mm, 4 mm, and 3 mm from the end.

In the subsequent experiments, the oxide superconducting thin film wires cut in the central portions that are not affected by edges of the oxide superconducting thin film wire before cutting were used among the oxide superconducting thin film wires after cutting. Specifically, the oxide superconducting thin film wires having widths of 4 mm, 2 mm, and 1 mm in the cutting with an infrared laser and the oxide superconducting thin film wire having a width of 4 mm in the cutting with an ultraviolet laser were used.

### (3) Heat Treatment in Oxygen

Two wire samples were cut out from the oxide superconducting thin film wire after cutting in each of Experimental Examples. One of the wire samples (Experimental Examples A-2, A-4, A-6, and A-8) was subjected to heat treatment in oxygen, that is, was heated to 550° C. at a pressure of 1 atmosphere in a pure oxygen gas atmosphere, held for 30 minutes, and then slowly cooled in a furnace.

### (4) Measurement of Ic

The critical current (Ic) in each of Experimental Examples was measured in liquid nitrogen by a four-terminal method. Furthermore, the normalized Ic (A/cm) was calculated based on the measurement results for each of Experimental Examples. Table 1 shows the results. FIG. 4 illustrates the relationship between the measurement results of Ic and the wire width in Experimental Examples A-1 to A-6.

### [Table 1]

TABLE 1

| | | Cutting width (mm) | | | | |
|---|---|---|---|---|---|---|
| | | | Actually | Heat | | Normalized |
| Experimetal | | Planned | measured | treatment in | Ic | Ic |
| Example | Cutting method | width | width | oxygen | (A) | (A/cm) |
| A-1 | Infrared laser | 4 | 3.97 | No | 257 | 647 |
| A-2 | Infrared laser | | | Yes | 273 | 688 |
| A-3 | Infrared laser | 2 | 2.00 | No | 107 | 535 |
| A-4 | Infrared laser | | | Yes | 137 | 685 |
| A-5 | Infrared laser | 1 | 0.98 | No | 27 | 271 |
| A-6 | Infrared laser | | | Yes | 63 | 643 |
| A-7 | Ultraviolet | 4 | 3.98 | No | 271 | 681 |
| | laser | | | | | |
| A-8 | Ultraviolet | | | Yes | 274 | 688 |
| | laser | | | | | |
| A-9 | Mechanical | 4 | 4.01 | No | 268 | 668 |
| | cutting | | | | | |

As is clear from Experimental Examples A-1 to A-6 in Table 1, Ic is higher in Experimental Examples with heat treatment in oxygen than in Experimental Examples without heat treatment in oxygen regardless of the wire width. This shows that Ic decreased by thermal cutting with an infrared laser can be recovered through heat treatment in oxygen.

In particular, as shown in Experimental Examples A-5 and A-6, Ic after slitting is considerably decreased for the wires subjected to thermal cutting so as to have a width of 1 mm, but Ic is considerably recovered through heat treatment in oxygen.

The normalized Ic after heat treatment in oxygen is substantially equal to the normalized Ic with an ultraviolet laser. This shows that cutting can be performed while the deterioration of the superconducting properties is sufficiently suppressed, despite the fact that the cutting speed of an infrared laser is about 10,000 times higher than that of an ultraviolet laser.

As illustrated in FIG. 4 in which the wire width after thermal cutting and Ic are plotted, Ic is estimated to be deteriorated at a wire width of about 0.12 mm. In FIG. 4, the solid-black circle indicates a measured value of a wire sample obtained without performing heat treatment in oxygen after thermal cutting. The solid-black triangle indicates a measured value of a wire sample obtained by performing heat treatment in oxygen after thermal cutting.

According to the first aspect of the present invention, there can be provided a method for producing an oxide superconducting thin film wire in which the deterioration of the superconducting properties can be sufficiently suppressed by recovering superconducting properties deteriorated by cutting an oxide superconducting thin film wire at a high cutting speed using an infrared laser.

The above-described first aspect of the present invention is a technique capable of efficiently producing, without deteriorating the superconducting properties, an oxide superconducting thin film wire by cutting an oxide superconducting thin film wire including, for example, a rare-earth-based oxide superconducting layer. This technique contributes to further promotion of practical use of oxide superconducting thin film wires.

### <2> Second Aspect

Next, an oxide superconducting thin film wire according to a second aspect of the present invention and a method for producing the oxide superconducting thin film wire will be described.

### [Specific Problem Solved in Second Aspect]

In the above-described production process of an oxide superconducting wire in the related art, formation of a stabilizing layer by copper plating or pasting of copper tape increases the cost and also increases the size of the wire.

In the case where an intermediate layer is formed of a conductive material, the intermediate layer has a new function of ensuring the conductivity between the superconducting layer and the metal substrate in addition to the existing functions such as the prevention of diffusion of elements into a superconducting layer and the lattice match with a superconducting layer. It is difficult to find out a material for the intermediate layer that is capable of sufficiently carrying out such various functions and is easily formed.

Accordingly, it is an object of the second aspect according to the present invention to provide an oxide superconducting thin film wire in which the conductivity between the oxide superconducting layer and the metal substrate can be easily ensured using a layer other than an intermediate layer without using the stabilizing layer that increases the cost and the wire size, and a method for producing the oxide superconducting thin film wire.

[Description of Second Aspect according to Present Invention]

Hereafter, embodiments of the second aspect according to the present invention will be listed and described.

(1) A method for producing an oxide superconducting thin film wire according to the second aspect of the present invention is a method for producing an oxide superconducting thin film wire by cutting an oxide superconducting thin film wire in which a REBa₂Cu₃O₇₋ₓ-based (RE: rare-earth element) oxide superconducting layer is formed above a belt-shaped metal substrate with an intermediate layer disposed therebetween, the oxide superconducting thin film wire being cut in a longitudinal direction with a desired width, the method including:

a thermal cutting step of thermally cutting the oxide superconducting thin film wire in a longitudinal direction by irradiating a portion to be cut with infrared laser light,

wherein in the thermal cutting step, by thermally cutting the oxide superconducting thin film wire, mixture layers obtained as a result of solidification of materials that constitute the oxide superconducting thin film wire and are melted during cutting are formed on both side surfaces of the cut oxide superconducting thin film wire, the mixture layers being formed as conductive layers that electrically connect the oxide superconducting layer and the metal substrate.

The present inventors have found that when a section of an oxide superconducting thin film wire obtained by thermal cutting through irradiation with infrared laser light is observed in solving the above problem, new layers are formed on both side surfaces that are cutting surfaces. On the other hand, such a layer is not formed when a mechanical cutting method that uses a slitter or the like or a cutting method that uses irradiation with ultraviolet laser light is employed.

As a result of analysis of materials constituting the layers, copper, silver, iron, nickel, barium, and a rare-earth element such as Gd are mainly detected. Thus, the layers are found to be layers formed of materials that constitute the oxide superconducting thin film wire and are melted during thermal cutting through irradiation with infrared laser light, that is, layers formed as a result of solidification of materials for a metal substrate, an oxide superconducting layer, and a protective layer in the form of a mixture.

Furthermore, the electrical resistance of the oxide superconducting thin film wire having such layers formed thereon has been measured between the front surface on the oxide superconducting layer side and the back surface on the metal substrate side. The electrical resistance is as low as 2 Ω or less per 1 cm of a wire length, which shows sufficiently high conductivity. The reason why the oxide superconducting thin film wire has such a low electrical resistance is probably that the layers are formed of materials constituting the oxide superconducting thin film wire as described above.

This aspect is based on the above findings. By forming such conductive layers, the stability during the passage of electric current can be ensured without disposing a stabilizing layer. Moreover, it is sufficient that such conductive layers are formed during thermal cutting through irradiation with infrared laser light. Therefore, the conductivity between the oxide superconducting layer and the metal substrate can be easily ensured without adding a function as an intermediate layer.

Since the stabilizing layer is not necessarily disposed, the cost can be reduced and also the size of the oxide superconducting thin film wire can be decreased, which can decrease the size of a device including the oxide superconducting thin film wire.

Even if the silver layer is disposed on the oxide superconducting layer as a protective layer as in the related art, the thickness of the silver layer can be set to 1 μm or less by ensuring the conductivity between the oxide superconducting layer and the metal substrate. Alternatively, the silver layer is not necessarily disposed. From this viewpoint, the cost can also be reduced.

The above-described conductive layers may contain materials constituting the intermediate layer. Although the intermediate layer is formed of ceramics and thus does not have conductivity, the amount of the materials contained in the conductive layers is small because the intermediate layer is thin, and thus the conductivity is not impaired.

An infrared laser that emits laser light having a wavelength of 1.0 to 1.1 μm is most suitable as a laser used for cutting among currently available laser processing apparatuses from the viewpoint of output and spot size.

By applying infrared laser light toward the metal substrate, materials for the metal substrate are melted first and thus conductive layers having a smooth surface can be formed on the side surfaces. Herein, an assist gas is preferably blown at the same time because the melted materials can be uniformly dispersed.

For the same reason as described in the method for producing an oxide superconducting thin film wire according to the first aspect, the oxide superconducting thin film wire after cutting is then preferably heat-treated in an oxygen gas atmosphere.

A protective layer and/or an insulating layer may be further formed on the oxide superconducting layer of the oxide superconducting thin film wire after cutting or on the periphery of the oxide superconducting thin film wire after cutting.

(2) An oxide superconducting thin film wire according to the second aspect of the present invention is an oxide superconducting thin film wire in which a REBa₂Cu₃O₇₋ₓ-based (RE: rare-earth element) oxide superconducting layer is formed above a belt-shaped metal substrate with an intermediate layer disposed therebetween,

wherein mixture layers obtained as a result of solidification of materials that constitute the oxide superconducting thin film wire are formed on both side surfaces as conductive layers that electrically connect the oxide superconducting layer and the metal substrate.

When mixture layers obtained as a result of solidification of materials that constitute the oxide superconducting thin film wire are formed on both side surfaces as conductive layers that electrically connect the oxide superconducting layer and the metal substrate as described above, the stability during the passage of electric current can be ensured without disposing a stabilizing layer. Therefore, a compact oxide superconducting thin film wire having excellent superconducting properties can be provided at low cost.

The electrical resistance between the oxide superconducting layer or the silver layer disposed on the oxide superconducting layer and the metal substrate is preferably 2 Ω or less per 1 cm of a wire length.

As described above, when the electrical resistance is as low as 2 Ω or less per 1 cm of a wire length, sufficient conductivity is ensured and the stability during the passage of electric current is ensured.

The metal substrate preferably includes at least a good conductor part that continuously extends in a longitudinal direction.

When such a metal substrate having a good conductor part is used, an overcurrent can be caused to efficiently flow from the conductive layers on the side surfaces to the metal substrate. Consequently, the function as a stabilizing layer can be appropriately imparted to the metal substrate. Examples of the metal substrate include orientated metal substrates formed of nickel, a Ni—W alloy, or the like; Ni-based heat-resistant alloy substrates such as Hastelloy; clad substrates including a copper layer as an orientated layer; and SUS. Among them, the clad substrate considerably produces a stabilizing effect because a copper layer having a low electrical resistance is included in a metal substrate.

(3) In the oxide superconducting thin film wire, oxide superconducting layers are preferably formed so as to sandwich the metal substrate, and an intermediate layer is disposed on both surfaces of the metal substrate and between each of the oxide superconducting layers and the metal substrate.

When oxide superconducting layers are formed so as to sandwich both surfaces of the metal substrate, the performance of a superconducting thin film wire can be improved. Thus, an oxide superconducting thin film wire having excellent superconducting properties such as higher Ic can be provided.

[Details of Embodiments of Second Aspect according to Present Invention]

Hereafter, an oxide superconducting thin film wire according to embodiments of the second aspect of the present invention and a method for producing the oxide superconducting thin film wire will be described with reference to the attached drawings.

### First Embodiment

### [1] Oxide Superconducting Thin Film Wire

### 1. Structure of Oxide Superconducting Thin Film Wire

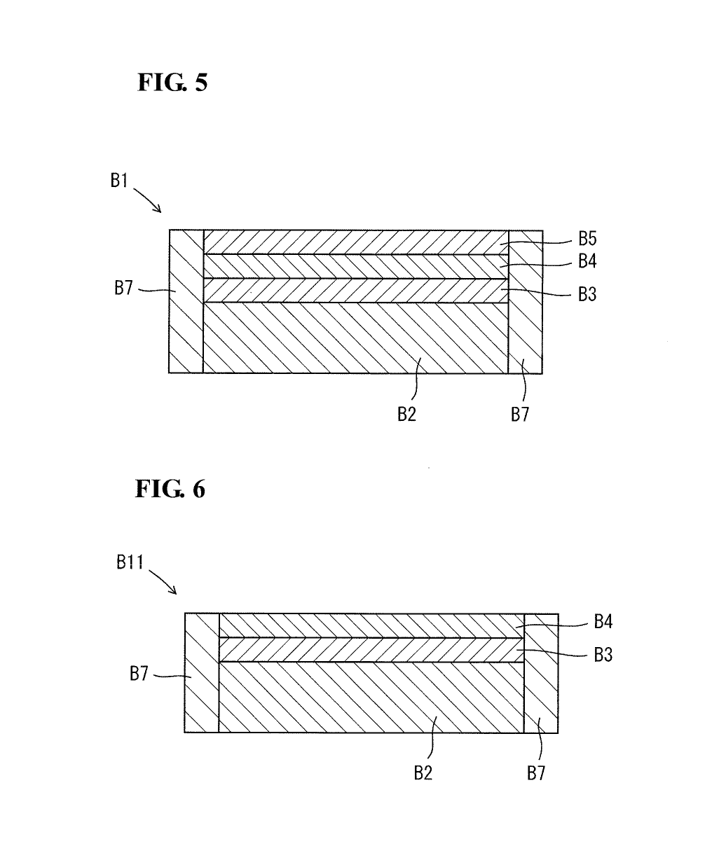

First, the structure of an oxide superconducting thin film wire according to a first embodiment will be described. FIG. 5 is a sectional view illustrating a structure of an oxide superconducting thin film wire according to a first embodiment.

In an oxide superconducting thin film wire B1 illustrated in FIG. 5, an intermediate layer B3, an oxide superconducting layer B4, an oxide superconducting layer B4, and a protective layer B5 are formed on a metal substrate B2 in this order.

Conductive layers B7 obtained as a result of solidification of materials for the metal substrate B2, the intermediate layer B3, the REBa₂Cu₃O₇₋ₓ (RE: rare-earth element) oxide superconducting layer B4, and the protective layer B5 (silver layer), the materials being cooled after melted by heat during thermal cutting, are formed on both side surfaces of the oxide superconducting thin film wire B1. Therefore, the conductive layers B7 are formed of a material for the metal substrate B2, a material for the intermediate layer B3, a material for the oxide superconducting layer B4, and silver in a mixed manner and thus has sufficient conductivity. As illustrated in FIG. 5, the conductive layers B7 electrically connect the protective layer B5 and the oxide superconducting layer B4 to the metal substrate B2.

### 2. Method for Producing Oxide Superconducting Thin Film Wire

The oxide superconducting thin film wire having the above-described structure is produced through the following procedure.

### (1) Production of Oxide Superconducting Thin Film Wire Before Cutting

First, an oxide superconducting thin film wire before cutting is produced by the same production method as the oxide superconducting thin film wire before cutting that has been described in the details of embodiments according to the first aspect.

### (2) Thermal Cutting Process

The produced oxide superconducting thin film wire before cutting is thermally cut in a longitudinal direction with a particular width using an infrared laser. Herein, portions irradiated with infrared laser light are melted by heat, and a melt containing materials for the metal substrate, the intermediate layer, the oxide superconducting layer, and the silver layer (as described above, the silver layer is not necessarily formed) in a mixed manner is generated. The melt adheres so as to cover the side surfaces of the oxide superconducting thin film wire produced by thermal cutting and then cools and solidifies. Thus, as illustrated in FIG. 5, conductive layers B7 each having a thickness of about 0.01 mm are formed on both side surfaces, and consequently the oxide superconducting layer B4 and the metal substrate B2 are electrically connected to each other at an electrical resistance of 2 Ω or less per 1 cm of the length of the oxide superconducting thin film wire.

Specifically, the thermal cutting is performed by the same method as the cutting and heat treatment in oxygen that have been described in the details of embodiments according to the first aspect.

### Second Embodiment

Next, a second embodiment will be described.

FIG. 6 is a sectional view illustrating a structure of an oxide superconducting thin film wire according to the second embodiment.

An oxide superconducting thin film wire B11 according to the second embodiment is different from the oxide superconducting thin film wire B1 according to the first embodiment in that the protective layer B5 formed in the oxide superconducting thin film wire B1 according to the first embodiment is not disposed.

Since the conductive layers B7 electrically connect the oxide superconducting layer B4 and the metal substrate B2, there is no need to dispose a conductive material on the oxide superconducting layer B4 and thus formation of a silver layer formed of expensive silver can be omitted. This can further reduce the production cost of the oxide superconducting thin film wire B11.

### Third Embodiment

Next, a third embodiment will be described.

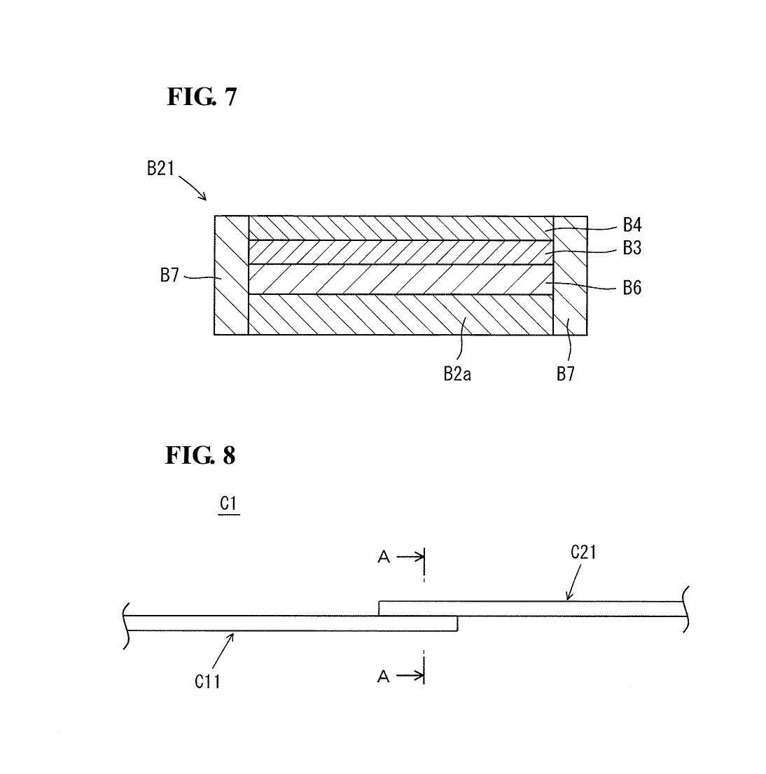

FIG. 7 is a sectional view illustrating a structure of an oxide superconducting thin film wire according to the third embodiment.

An oxide superconducting thin film wire B21 according to the third embodiment is different from the oxide superconducting thin film wire B1 according to the second embodiment in that a clad metal substrate is used as the metal substrate of the oxide superconducting thin film wire B11 according to the second embodiment.

The clad metal substrate is provided by disposing a copper layer B6 having excellent conductivity and serving as an orientated layer on a substrate B2a containing SUS or the like as a base metal. This can further improve an effect of suppressing an overcurrent in the oxide superconducting thin film wire B21 during the passage of electric current by the conductive layers B7.

A protective layer may be disposed on the superconducting layer of the superconducting thin film wire, or an insulating layer may be disposed around the superconducting thin film wire.

### EXPERIMENTAL EXAMPLES

Next, the second aspect of the present invention will be more specifically described based on Experimental Examples.

Herein, an oxide superconducting thin film wire was cut by different cutting methods such as cutting with an infrared laser and cutting with an ultraviolet laser. Thus, oxide superconducting thin film wires according to Experimental Examples B-1 to B-4 were produced with or without heat treatment in oxygen. For each of the produced oxide superconducting thin film wires, Ic was measured and the electrical resistance between the front surface on the oxide superconducting layer side and the back surface on the metal substrate side was measured at the conductive layers.

### (1) Production of Oxide Superconducting Thin Film Wire Before Cutting

An oxide superconducting thin film wire having a width of 10 mm was produced in the same manner as described in [Experimental Examples] of the first aspect.

### (2) Cutting Conditions

The produced oxide superconducting thin film wire having a width of 10 mm was thermally cut using an infrared laser in Experimental Examples B-1 and B-2 and non-thermally cut using an ultraviolet laser in Experimental Examples B-3 and B-4.

The cutting conditions were set to the same cutting conditions as described in [Experimental Examples] of the first aspect. In the subsequent measurement, an oxide superconducting thin film wire cut so as to have a width of 4 mm was used.

### (3) Heat Treatment in Oxygen

Two wire samples were cut out from the cut oxide superconducting thin film wire having a width of 4 mm. One of the wire samples (Experimental Examples B-1 and B-3) was subjected to heat treatment in oxygen, that is, was heated to 550° C. at a pressure of 1 atmosphere in a pure oxygen gas atmosphere, held for 30 minutes, and then slowly cooled in a furnace.

### (4) Measurement of Electrical Resistance

The section of the wire sample (Experimental Example B-1) thermally cut with an infrared laser was observed. The side surfaces were found to be covered with layers having a thickness of about 0.01 mm. Cu, Ag, Fe, Ni, Ba, Gd, and the like were mainly detected from the layers. This result showed that the layers were formed of a material for the metal substrate, a material for the oxide superconducting layer, and silver in the silver layer in a mixed manner, the materials and silver being melted by heat during thermal cutting with an infrared laser.

Then, the electrical resistance between the front surface and the back surface of the wire samples was measured. The electrical resistance was 1.1 Ω per 1 cm of a wire length in the case where the heat treatment in oxygen was not performed (Experimental Example B-1). The electrical resistance was 0.4 Ω per 1 cm of a wire length in the case where the heat treatment in oxygen was performed (Experimental Example B-2). This showed that the layers had sufficient conductivity. In contrast, the wire sample (Experimental Example B-3) which was thermally cut with an ultraviolet laser and in which such layers were not formed was found to have a large resistance of 1200 Ω per 1 cm of a wire length.

### (5) Measurement of Ic

The critical current (Ic) of each wire sample was measured in liquid nitrogen by a four-terminal method. The normalized Ic (A/cm) calculated based on the measurement results in each of Experimental Examples was 647 to 688 A/cm.

According to the second aspect of the present invention, there can be provided an oxide superconducting thin film wire in which the conductivity between the oxide superconducting layer and the metal substrate can be easily ensured using a layer other than an intermediate layer without using the stabilizing layer that increases the cost and the wire size, and a method for producing the oxide superconducting thin film wire.

The oxide superconducting thin film wire according to the second aspect of the present invention and the method for producing the oxide superconducting thin film wire can reduce the cost required to form a stabilizing layer, take measures against overcurrent, and enable ease of production. They are useful for an oxide superconducting thin film wire in which an oxide superconducting layer is disposed and a method for producing the oxide superconducting thin film wire.

### <3> Third Aspect

The third aspect of the present invention is also effective for stabilizing a connected portion of superconducting thin film wires.

### [Specific Problem Solved in Third Aspect]

PTL 8 proposes a method for connecting oxide superconducting layers by removing stabilizing layers formed on the surfaces of the oxide superconducting layers and performing heating while the oxide superconducting layers are in contact with each other. In this case, the stabilizing layers are not present in a connected portion. Therefore, when an overcurrent flows through the connected portion, the oxide superconducting layers may be broken.

PTL 9 discloses a method for connecting oxide superconducting thin film wires in which a stabilizing layer is formed. In this case, if the stabilizing layer is excessively thick, the thickness of the connected portion is much larger than that of other portions. Consequently, it may be difficult to use the oxide superconducting thin film wire in the production of superconducting cables, superconducting coils, and the like, or the electrical resistance in the connected portion may increase.

Accordingly, it is an object of the third aspect of the present invention to provide a technique in which in the case where a plurality of oxide superconducting thin film wires are sequentially connected to each other, when an overcurrent flows through the connected portion, an oxide superconducting layer can be prevented from being broken even if stabilizing layers are not disposed in the end portions of the oxide superconducting thin film wires.

[Description of Third Aspect according to Present Invention]

First, embodiments of the third aspect according to the present invention will be listed and described.

(1) A method for producing an oxide superconducting thin film wire according to the third aspect of the present invention is a method for producing an oxide superconducting thin film wire lengthened by sequentially connecting end portions of oxide superconducting thin film wires in which at least an intermediate layer and an oxide superconducting layer are laminated on a metal substrate, the method including:

an overlapping step of overlapping surfaces of the oxide superconducting thin film wires on the oxide superconducting layer side; and

a conductive layer-forming step of thermally cutting the overlapped oxide superconducting thin film wires in a longitudinal direction using an infrared laser to form mixture layers obtained as a result of solidification of materials that constitute the oxide superconducting thin film wires and are melted during cutting on both side surfaces of an overlapped portion of the cut oxide superconducting thin film wires, the mixture layers being formed as conductive layers that electrically connect the oxide superconducting layer and the metal substrate.

As described above, in the related art, oxide superconducting thin film wires are cut so as to have a desired width before they are connected to each other. The present inventors have found from experiments that when surfaces of oxide superconducting thin film wires on the oxide superconducting layer side are overlapped with each other and then the overlapped oxide superconducting thin film wires are thermally cut in a longitudinal direction using an infrared laser, mixture layers obtained as a result of solidification of materials for layers (e.g., a metal substrate, an oxide superconducting layer, and an intermediate layer) of the oxide superconducting thin film wires, the materials being melted by heat during cutting, are formed on the side surfaces of the overlapped portion. On the other hand, such a layer is not formed when a mechanical cutting method that uses a slitter or the like or a cutting method that uses an ultraviolet laser is employed.

The layers formed through irradiation with infrared laser light contain conductive materials such as materials for the oxide superconducting layer and the metal substrate. Therefore, the layers can be caused to function as conductive layers that electrically connect the oxide superconducting layer and the metal substrate. Furthermore, an overcurrent generated in the oxide superconducting layer can be caused to flow to the metal substrate through the conductive layers. Therefore, the function as a stabilizing layer in the related art can be imparted to the conductive layers and the metal substrate. As a result, even if a stabilizing layer is not disposed in an end portion of the oxide superconducting thin film wire, the oxide superconducting layer can be appropriately prevented from being broken by an overcurrent. According to this aspect, the overlapped oxide superconducting layers can be electrically connected to each other through the conductive layers with certainty.

Herein, the infrared laser is preferably an infrared laser that emits laser light having a wavelength of 1.0 to 1.1 μm.

That is, an infrared laser that emits laser light having a wavelength of 1.0 to 1.1 μm is most suitable among currently available laser processing apparatuses from the viewpoint of output and spot size.

In the present invention, the oxide superconducting thin film wires are preferably connected to each other such that oxide superconducting layers are overlapped with each other, one oxide superconducting layer and a silver layer formed on the other oxide superconducting layer are overlapped with each other, or silver layers formed on both oxide superconducting layers are overlapped with each other. In addition, for example, heating and pressurizing may be performed when the oxide superconducting thin film wires are connected to each other.

In the case where a silver layer is disposed on the oxide superconducting layer, two oxide superconducting thin film wires may be connected to each other by overlapping the silver layers. In this case, the conductive layers formed on the side surfaces of the oxide superconducting thin film wires contain silver, which can further decrease the electrical resistance of the conductive layers and further improve the conductivity.

During the irradiation with infrared laser light, an assist gas is preferably blown at the same time because the conductive layers can be uniformly formed on the side surfaces of the connected portion.

As in the second aspect, the oxide superconducting thin film wires are preferably heat-treated in an oxygen gas atmosphere.

(2) An oxide superconducting thin film wire according to the third aspect of the present invention is an oxide superconducting thin film wire lengthened by sequentially connecting end portions of oxide superconducting thin film wires in which at least an intermediate layer and an oxide superconducting layer are laminated on a metal substrate,

wherein mixture layers obtained as a result of solidification of materials that constitute the oxide superconducting thin film wires are formed on both side surfaces of a connected portion of the oxide superconducting thin film wires, the mixture layers being formed as conductive layers that electrically connect the oxide superconducting layer and the metal substrate.

As described above, by forming conductive layers containing materials for the metal substrate, the oxide superconducting layer, and the like on the side surfaces of the oxide superconducting thin film wire, the oxide superconducting layer and the metal substrate can be electrically connected to each other through the conductive layers and thus the function as a stabilizing layer in the related art can be imparted to the metal substrate. Therefore, even if the stabilizing layer is not disposed in a connected portion, the oxide superconducting layer can be appropriately prevented from being broken by an overcurrent.

(3) The metal substrate preferably includes at least a good conductor part that continuously extends in a longitudinal direction.

By using such a metal substrate including a good conductor part, an overcurrent generated can be efficiently caused to flow to the metal substrate and thus the function as a stabilizing layer can be appropriately imparted to the metal substrate. Such a metal substrate including a good conductor part is, for example, a clad substrate having a layered structure including a copper layer.

By forming an insulating layer on the outer periphery of the produced oxide superconducting thin film wire, the wire can be insulated from the surroundings. Thus, the produced oxide superconducting thin film wire can be easily applied to devices.

[Details of Embodiments of Third Aspect according to Present Invention]

Hereafter, a third aspect of the present invention will be described based on embodiments with reference to the attached drawings.

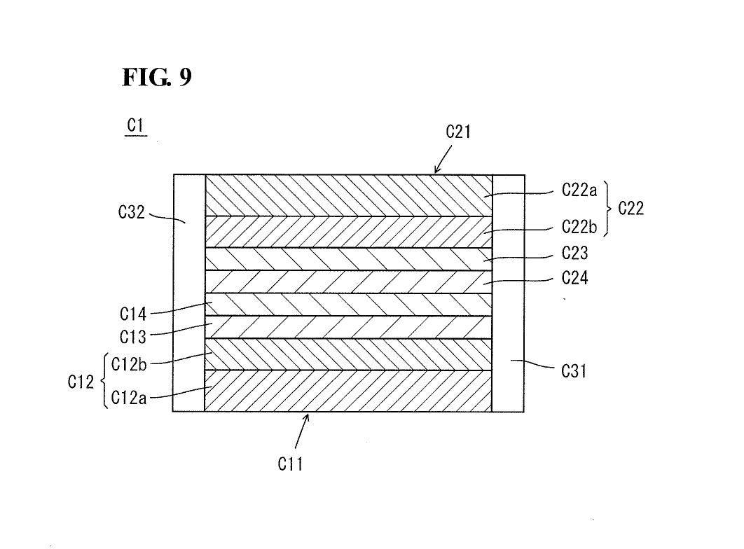

FIG. 8 is a side view schematically illustrating an oxide superconducting thin film wire according to this embodiment. Two oxide superconducting thin film wires C11 and C21 are overlapped to achieve lengthening. FIG. 9 is a sectional view taken along line A-A in FIG. 8. An oxide superconducting thin film wire C11 in which an intermediate layer C13 and an oxide superconducting layer C14 are laminated on a metal substrate C12 and an oxide superconducting thin film wire C21 in which an intermediate layer C23 and an oxide superconducting layer C24 are laminated on a metal substrate C22 are connected to each other such that the oxide superconducting layers C14 and C24 face each other. C31 and C32 denote conductive layers formed during thermal cutting. Hereafter, the production procedure of an oxide superconducting thin film wire C1 illustrated in FIG. 8 and FIG. 9 will be described.

### 1. Production of Oxide Superconducting Thin Film Wire Before Connection

(1) An oxide superconducting thin film wire before connection is produced by the same production method as the oxide superconducting thin film wire before cutting that has been described in the details of embodiments of the first aspect.

### (2) Formation of Stabilizing Layer

Next, if necessary, a stabilizing layer formed of copper or a copper alloy is formed on the surface of the oxide superconducting thin film wire on the oxide superconducting layer side or on the entire peripheral surface of the oxide superconducting thin film wire. Thus, an oxide superconducting thin film wire is produced. Herein, if the stabilizing layer is formed, the stabilizing layer is preferably removed in a connected portion.

### 2. Connection of Oxide Superconducting Thin Film Wires

In this embodiment, the produced oxide superconducting thin film wires are sequentially connected to each other to produce a lengthened oxide superconducting thin film wire. Hereafter, each step in the connection of the oxide superconducting thin film wires will be described.

### (1) Stabilizing Layer-Removing Step

In this embodiment, before the oxide superconducting thin film wires are overlapped and connected, the stabilizing layer and a silver layer are removed from an end portion of each oxide superconducting thin film wire to expose the oxide superconducting layer.

### (2) Overlapping Step

Next, surfaces of end portions of the oxide superconducting thin film wires on the oxide superconducting layer side ate overlapped with each other. Specifically, the oxide superconducting thin film wires are overlapped with each other such that uppermost layers of the oxide superconducting thin film wires on the oxide superconducting layer side face each other. In this embodiment, two oxide superconducting thin film wires C11 and C21 are overlapped with each other such that the oxide superconducting layers exposed by removing the stabilizing layers face each other, and then the overlapped portion is fixed using a pressurizing jig (not illustrated).

### (3) Conductive Layer-Forming Step

Next, the overlapped oxide superconducting thin film wires C11 and C21 are cut in a longitudinal direction to obtain slit oxide superconducting thin film wires. In this embodiment, by using thermal cutting with an infrared laser for slitting the oxide superconducting thin film wires, the conductive layers C31 and C32 are formed on the side surfaces of the oxide superconducting thin film wires C11 and C21 as illustrated in FIG. 9.

Specifically, by thermally cutting the oxide superconducting thin film wires with an infrared laser, each layer (e.g., metal substrates C12 and C22 and oxide superconducting layers C14 and C24) constituting the oxide superconducting thin film wires C11 and C21 is melted and then solidified. Thus, mixture layers obtained as a result of solidification of conductive materials for each layer, such as Cu, Fe, Ni, Ba, and a rare-earth element, e.g., Gd, are formed as the conductive layers C31 and C32 so as to cover the side surfaces of the oxide superconducting thin film wires.

When the conductive layers C31 and C32 are formed on the side surfaces of the oxide superconducting thin film wires C11 and C21 as described above, the metal substrates C12 and C22 and the oxide superconducting layers C14 and C24 are electrically connected to each other through the conductive layers C31 and C32.

In the oxide superconducting thin film wire C1 lengthened by the production method according to this embodiment, overcurrents generated in the oxide superconducting layers C14 and C24 can be caused to flow to the metal substrates C12 and C22 through the conductive layers C31 and C32. In other words, since the function as a stabilizing layer in the related art can be imparted to the metal substrates C12 and C22, the oxide superconducting layers can be appropriately prevented from being broken by an overcurrent even if the stabilizing layer is not disposed in the connected portion.

In this embodiment, the overlapped oxide superconducting layers C14 and C24 can be electrically connected to each other through the conductive layers C31 and C32. Therefore, the oxide superconducting layers C14 and C24 can be connected to each other with certainty.

Specifically, the thermal cutting is performed by the same cutting method as described in the details of embodiments of the first aspect.

3. Method for Producing Oxide Superconducting Thin Film Wire according to Other Embodiments

In the above embodiment, by thermally cutting the oxide superconducting thin film wires C11 and C12 with an infrared laser after the oxide superconducting layers are directly overlapped with each other, the conductive layers C31 and C32 are formed so as to lie across the oxide superconducting thin film wires C11 and C21, and the conductive layers C31 and C32 electrically connect the oxide superconducting layers C14 and C24 to each other.

However, the present invention is not limited thereto. Before the thermal cutting with an infrared laser, an overlapped portion of the oxide superconducting thin film wires C11 and C21 may be heated to connect the oxide superconducting layers C14 and C24 to each other. In this case, since the oxide superconducting layers C14 and C24 are directly connected to each other, the strength of a connected portion can be improved and furthermore a connected portion which has an ultra-low resistance and through which electric current more stably passes can be formed.

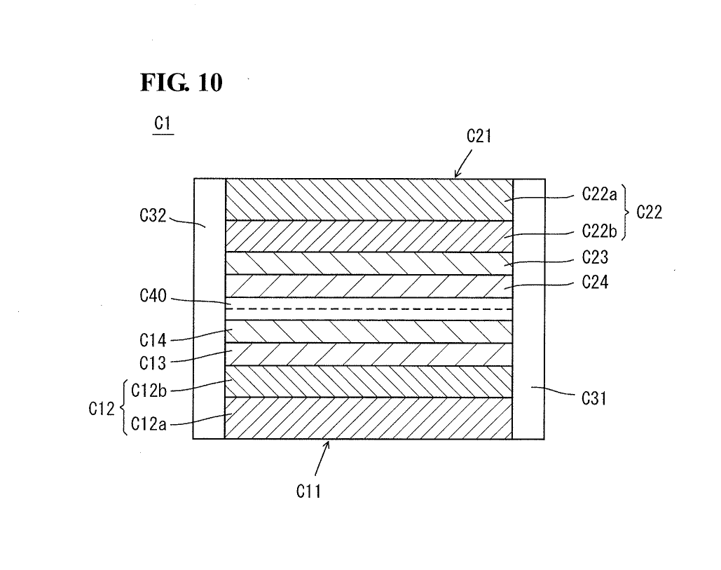

For example, when silver layers C40 are disposed on the oxide superconducting layers C14 and C24 before overlapping as illustrated in FIG. 10, two oxide superconducting thin film wires C11 and C21 may be connected to each other by forming the conductive layers C31 and C32 after the sliver layers C40 are overlapped with each other.

When the oxide superconducting thin film wire is thermally cut with an infrared laser in the conductive layer-forming step, oxygen comes out of the oxide superconducting layer by heat of infrared laser light, which sometimes deteriorates the superconducting properties. Therefore, after the conductive layer-forming step, so-called oxygen annealing is preferably performed in which the oxide superconducting thin film wire is heat-treated in an oxygen gas atmosphere. This causes oxygen to enter the oxide superconducting layer again, and the superconducting properties can be recovered.

As described above, the metal substrate may be a clad substrate, an orientated metal substrate, a Ni-based heat-resistant alloy substrate, or a SUS substrate and is preferably a clad substrate including a copper layer serving as a good conductor. By using a metal substrate including a layer serving as a good conductor, an overcurrent can be efficiently caused to flow to the metal substrate. The copper layer preferably has a thickness of 10 to 70 μm.

### EXPERIMENTAL EXAMPLES

The third aspect of the present invention will be more specifically described based on Experimental Examples.

In Experimental Examples, when a plurality of oxide superconducting thin film wires were connected to each other, overlapped oxide superconducting thin film wires were cut in a longitudinal direction by different cutting methods in Experimental Examples C-1 and C-2, and whether conductive layers were formed on the side surfaces of the oxide superconducting thin film wires was checked.

### (1) Production of Oxide Superconducting Thin Film Wire Before Cutting

An oxide superconducting thin film wire having a width of 10 mm was produced by the same method as described in the production of the wide oxide superconducting thin film wire (before cutting) in [Experimental Examples] of the first aspect.

### (2) Overlapping Conditions

In both Experimental Example C-1 and Experimental Example C-2, two oxide superconducting thin film wires were overlapped with each other such that silver layers in end portions of the oxide superconducting thin film wires were directly in contact with each other, and the overlapped portion was fixed using a pressurizing jig.

### (3) Cutting (Slitting) Conditions

In Experimental Example C-1, the overlapped oxide superconducting thin film wires were thermally cut with an infrared laser (fiber laser). In Experimental Example C-2, the overlapped oxide superconducting thin film wires were non-thermally cut with an ultraviolet laser. In Experimental Example C-1 in which an infrared laser was used, the overlapped oxide superconducting thin film wires were thermally cut through irradiation with infrared laser light while an assist gas was being blown. The cutting width was set to 4 mm in both Experimental Example C-1 and Experimental Example C-2.

The cutting conditions were set to the same cutting conditions as described in [Experimental Examples] of the first aspect.

### (4) Heat Treatment in Oxygen

The oxide superconducting thin film wires were subjected to heat treatment in oxygen, that is, were heated to 550° C. at a pressure of 1 atmosphere in a pure oxygen gas atmosphere, held for 30 minutes, and then slowly cooled in a furnace.

### (5) Observation of Section

The sections of the lengthened oxide superconducting thin film wires in Experimental Example C-1 and Experimental Example C-2 were observed. Layers having a thickness of about 0.01 mm were formed on both side surfaces of the oxide superconducting thin film wires.

As a result of analysis of the layers formed in Experimental Example C-1 and Experimental Example C-2, Cu, Ag, Fe, Ni, Ba, Gd, and the like were mainly detected from the layers. This showed that, by performing thermal cutting with an infrared laser, mixture layers obtained as a result of solidification of melted materials for the oxide superconducting thin film wires were formed on the side surfaces of the oxide superconducting thin film wires.

### (6) Evaluation of Conductivity on Side Surfaces

Next, the electrical resistance between the front surface and the back surface in the connected portion of the oxide superconducting thin film wires in Experimental Example C-1 and Experimental Example C-2 was measured to check whether the layers formed on the side surfaces of the oxide superconducting thin film wires in Experimental Example C-1 and Experimental Example C-2 had conductivity.

As a result, the electrical resistance between the front surface and the back surface of the oxide superconducting thin film wires in Experimental Example C-2 in which non-thermal cutting with an ultraviolet laser was performed was 1200 Ω per 1 cm. In contrast, the electrical resistance between the front surface and the back surface of the oxide superconducting thin film wires in Experimental Example C-1 in which the mixture layers were formed on the side surfaces by performing thermal cutting with an infrared laser was 1.1 Ω per 1 cm.

This showed that the layers formed on the side surfaces of the oxide superconducting thin film wires in Experimental Example C-1 in which thermal cutting with an infrared laser was performed were conductive layers that electrically connect the layers in the connected portion.

According to the third aspect of the present invention, there can be provided a technique in which in the case where a plurality of oxide superconducting thin film wires are sequentially connected to each other, when an overcurrent flows through the connected portion, an oxide superconducting layer can be prevented from being broken even if stabilizing layers are not disposed in the end portions of the oxide superconducting thin film wires.

The third aspect of the present invention prevents the oxide superconducting layer from being broken by an overcurrent without forming a stabilizing layer in a connected portion, prevents an excessive increase in the thickness of the connected portion, and prevents an increase in the electrical resistance in the connected portion. The third aspect contributes to improving the production efficiency of and reducing the production cost of, for example, superconducting cables and superconducting coils used in a persistent current mode.

### REFERENCE SIGNS LIST

A1, A11, A21 oxide superconducting thin film wire

A2 metal substrate

A3 intermediate layer

A4 oxide superconducting layer

A5 silver layer

A6 stabilizing layer

A7 insulating layer

B1, B11, B21 oxide superconducting thin film wire

B2 metal substrate

B2a substrate

B3 intermediate layer

B4 oxide superconducting layer

B5 protective layer

B6 copper layer

B7 conductive layer

C1 lengthened oxide superconducting thin film wire

C11, C21 oxide superconducting thin film wire

C12, C22 metal substrate

C12a, C22a SUS substrate

C12b, C22b copper layer

C13, C23 intermediate layer

C14, C24 oxide superconducting layer

C31, C32 conductive layer

C40 silver layer

W cutting width

1. A method for producing an oxide superconducting thin film wire having a particular width, the method comprising:
a cutting step of cutting a wide oxide superconducting thin film wire in a longitudinal direction with the particular width, the wide oxide superconducting thin film wire being obtained by forming an oxide superconducting layer above a belt-shaped metal substrate with an intermediate layer disposed therebetween,
wherein in the cutting step, the wide oxide superconducting thin film wire is thermally cut in the longitudinal direction with the particular width by irradiating, with infrared laser light, a portion of the wide oxide superconducting thin film wire to be cut.

2. A method for producing an oxide superconducting thin film wire by forming a REBa₂Cu₃O₇₋ₓ-based (RE: rare-earth element) oxide superconducting layer above a belt-shaped metal substrate with an intermediate layer disposed therebetween and then performing cutting in a longitudinal direction with a particular width, the method comprising:
a step of performing thermal cutting in a longitudinal direction with a particular width by irradiating a portion to be cut with infrared laser light; and
a step of heat-treating the thermally cut oxide superconducting thin film wire in an oxygen gas atmosphere.

3. The method for producing an oxide superconducting thin film wire according to claim 2, wherein the oxide superconducting thin film wire is produced by performing thermal cutting so as to have a width of 1 mm or less.

4. A method for producing an oxide superconducting thin film wire by cutting an oxide superconducting thin film wire in which a REBa₂Cu₃O₇₋ₓ-based (RE: rare-earth element) oxide superconducting layer is formed above a belt-shaped metal substrate with an intermediate layer disposed therebetween, the oxide superconducting thin film wire being cut in a longitudinal direction with a desired width, the method comprising:
a thermal cutting step of thermally cutting the oxide superconducting thin film wire in a longitudinal direction by irradiating a portion to be cut with infrared laser light,
wherein in the thermal cutting step, by thermally cutting the oxide superconducting thin film wire, mixture layers obtained as a result of solidification of materials that constitute the oxide superconducting thin film wire and are melted during cutting are formed on both side surfaces of the cut oxide superconducting thin film wire, the mixture layers being formed as conductive layers that electrically connect the oxide superconducting layer and the metal substrate.

5. An oxide superconducting thin film wire in which a REBa₂Cu₃O₇₋ₓ-based (RE: rare-earth element) oxide superconducting layer is formed above a belt-shaped metal substrate with an intermediate layer disposed therebetween,
wherein mixture layers obtained as a result of solidification of materials that constitute the oxide superconducting thin film wire are formed on both side surfaces as conductive layers that electrically connect the oxide superconducting layer and the metal substrate.

6. The oxide superconducting thin film wire according to claim 5, wherein oxide superconducting layers are formed so as to sandwich the metal substrate, and an intermediate layer is disposed on both surfaces of the metal substrate and between each of the oxide superconducting layers and the metal substrate.

7. A method for producing an oxide superconducting thin film wire lengthened by sequentially connecting end portions of oxide superconducting thin film wires in which at least an intermediate layer and an oxide superconducting layer are laminated on a metal substrate, the method comprising:
an overlapping step of overlapping surfaces of the oxide superconducting thin film wires on the oxide superconducting layer side; and
a conductive layer-forming step of thermally cutting the overlapped oxide superconducting thin film wires in a longitudinal direction using an infrared laser to form mixture layers obtained as a result of solidification of materials that constitute the oxide superconducting thin film wires and are melted during cutting on both side surfaces of an overlapped portion of the cut oxide superconducting thin film wires, the mixture layers being formed as conductive layers that electrically connect the oxide superconducting layer and the metal substrate.

8. An oxide superconducting thin film wire lengthened by sequentially connecting end portions of oxide superconducting thin film wires in which at least an intermediate layer and an oxide superconducting layer are laminated on a metal substrate,
wherein mixture layers obtained as a result of solidification of materials that constitute the oxide superconducting thin film wires are formed on both side surfaces of a connected portion of the oxide superconducting thin film wires, the mixture layers being formed as conductive layers that electrically connect the oxide superconducting layer and the metal substrate.

9. The oxide superconducting thin film wire according to claim 5, wherein the metal substrate includes at least a good conductor part that continuously extends in a longitudinal direction.

10. The oxide superconducting thin film wire according to claim 8, wherein the metal substrate includes at least a good conductor part that continuously extends in a longitudinal direction.
